(19) United States
(12) Patent Application Publication
(10) Pub. No.: US 2012/0195661 A1
(43) Pub. Date: Aug. 2, 2012

(54) Lubricant Supplying Device, Process Cartridge, And Image Forming Apparatus

(75) Inventors: Shinya Karasawa, Kanagawa (JP); Ken Amemiya, Tokyo (JP); Michiya Okamoto, Kanagawa (JP); Takuma Iwasaki, Kanagawa (JP); Yuta Azeyanagi, Kanagawa (JP)

(73) Assignee: RICOH COMPANY, LIMITED, Tokyo (JP)

(21) Appl. No.: 13/349,054

(22) Filed: Jan. 12, 2012

(30) Foreign Application Priority Data
Jan. 27, 2011 (JP) 2011-014799

(51) Int. Cl. G03G 21/00

(52) U.S. Cl. 399/346

(57) ABSTRACT

A lubricant supplying device includes a compressing spring that has one end coming into contact with a holding member in order to bias a solid lubricant toward a lubricant supplying roller and a casing that covers the outside of the device. Then, the casing includes an opening portion that allows the other end of the compressing spring, having the one end coming into contact with the holding member, to be exposed therethrough, and the casing further includes a cover member that is installed in the opening portion in a removable manner so that the cover member comes into contact with the other end of the compressing spring.

### CROSS-REFERENCE TO RELATED APPLICATIONS

The present application claims priority to and incorporates by reference the entire contents of Japanese Patent Application No. 2011-014799 filed in Japan on Jan. 27 2011.

### BACKGROUND OF THE INVENTION

1. Field of the Invention

The present invention relates to an electro-photographic image forming apparatus such as a copying machine, a printer, a facsimile, or a multi-functional peripheral thereof, to a lubricant supplying device installed therein, and also to a process cartridge.

2. Description of the Related Art

Hitherto, in an image forming apparatus such as a copying machine or a printer, there is a known technique using a lubricant supplying device which supplies a lubricant to an image carrier such as a photosensitive drum or an intermediate transfer belt (for example, see Japanese Patent Application Laid-open No. 2006-201565 and Japanese Patent Application Laid-open No. 2001-305907).

Specifically, non-transferred toner which remains on a photosensitive drum after a transfer process needs to be completely removed by a cleaning blade (a cleaning device) which comes into contact with the photosensitive drum. However, in a case in which a contact portion of the cleaning blade is chipped (damaged) due to the friction against the photosensitive drum, the non-transferred toner goes through a gap between the damaged cleaning blade and the photosensitive drum, which results in a cleaning defect.

In order to solve this problem, a method may be considered in which a lubricant is coated onto the photosensitive drum so as to reduce a friction coefficient on the photosensitive drum. This method reduces the abrasion and the damage of the cleaning blade or the deterioration of the photosensitive drum, and as a result, the cleaning defect with an elapse of time may be suppressed.

Specifically, in Japanese Patent Application Laid-open No. 2006-201565 and Japanese Patent Application Laid-open No. 2001-305907, a lubricant coating device includes: a brush roller (a lubricant supplying roller) which slides on a photosensitive drum (an image carrier); a solid lubricant which comes into contact with the brush roller; a holding member which holds the solid lubricant; and a compressing spring which biases the solid lubricant and the holding member in the press-contact direction toward the brush roller. Then, the lubricant is gradually scraped off the solid lubricant by the brush roller which rotates in a predetermined direction, and the lubricant which is scraped off and conveyed by the brush roller is coated on (supplied to) the surface of the image carrier. Here, the compressing springs which bias the solid lubricant in the press-contact direction are provided at both end portions of a casing, respectively in the width direction between the casing (the exterior cover) and the holding member which holds the solid lubricant.

In the lubricant supplying device of the related arts, since the compressing springs which are used to bias the solid lubricant in the press-contact direction are attached to the casing in a manner that the compressing springs may not be seen between the holding member and the casing, the compressing springs are attached to the casing in a buckled state or the compressing springs slip off the casing, which easily results in the defective assembly of the compressing springs. Then, when such problems arise, the original function of the lubricant supplying device may not be exhibited.

### SUMMARY OF THE INVENTION

It is an object of the present invention to at least partially solve the problems in the conventional technology, by providing a lubricant supplying device, a process cartridge, and an image forming apparatus in which an assembly defect of a compressing spring used to bias a solid lubricant in the press-contact direction scarcely occurs.

In order to solve the aforementioned problems, a lubricant supplying device that supplies a lubricant to an image carrier that carries a toner image according to one aspect of the present invention is constructed in such a manner as to include: a lubricant supplying roller that rotates in a predetermined direction and slides on the image carrier; a solid lubricant that slides on the lubricant supplying roller; a holding member that holds the solid lubricant; a compressing spring with one end being brought into contact with the holding member, thereby biasing the solid lubricant toward the lubricant supplying roller; and a casing that covers the outside of the device, wherein the casing includes an opening portion that allows the other end of the compressing spring, having the one end coming into contact with the holding member, to be exposed therethrough, and a cover member that is installed in the opening portion in a removable manner so that the cover member comes into contact with the other end of the compressing spring and determines a biasing force of the compressing spring.

Further, a process cartridge, which is installed in an image forming apparatus main body so as to be attachable thereto and detachable therefrom, according to another aspect of the present invention is constructed in such a manner as to include the above-mentioned lubricant supplying device and the image carrier.

Still further, an image forming apparatus according to still another aspect of the present invention is constructed in such a manner as to include the above-mentioned lubricant supplying device and the image carrier.

By the way, in the specification of the present application, the term ‘process cartridge’ is defined as a unit that may be removably installed in the image forming apparatus main body and that is provided with an image carrier integrated with at least one of the charging unit which charges the image carrier, the developing unit (the developing device) which develops the latent image formed on the image carrier, and the cleaning unit which cleans the surface of the image carrier.

Further, in the specification of the present application, the term ‘width direction’ is defined as a direction which is perpendicular to the direction in which the recording medium is conveyed, and which is the same direction as the main-scanning direction in the image carrier.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an entire configuration diagram illustrating an image forming apparatus according to an embodiment of the invention;

FIG. 2 is a configuration diagram illustrating an image forming unit;

FIG. 3 is a perspective view illustrating a process cartridge;

FIG. 4 is a perspective view illustrating a state where a cover member is attached to and detached from the process cartridge of FIG. 3;

FIG. 5 is an enlarged perspective view illustrating a state where a compressing spring is set;

FIG. 6 is an enlarged perspective view illustrating a state where the cover member is set;

FIG. 7 is a cross-sectional view illustrating a state where the compressing spring and the cover member are set;

FIG. 8 is a perspective view illustrating a holding member that holds a solid lubricant;

FIG. 9 is a perspective view illustrating the cover member; and

FIG. 10 is another perspective view illustrating the cover member.

### DETAILED DESCRIPTION OF THE PREFERRED EMBODIMENTS

### Embodiment

Hereinafter, an embodiment of the invention will be described in detail with reference to the drawings. Furthermore, in the respective drawings, the same reference signs are given to the same or equivalent constituents, and the repetitive description thereof will be appropriately simplified or will not be repeated.

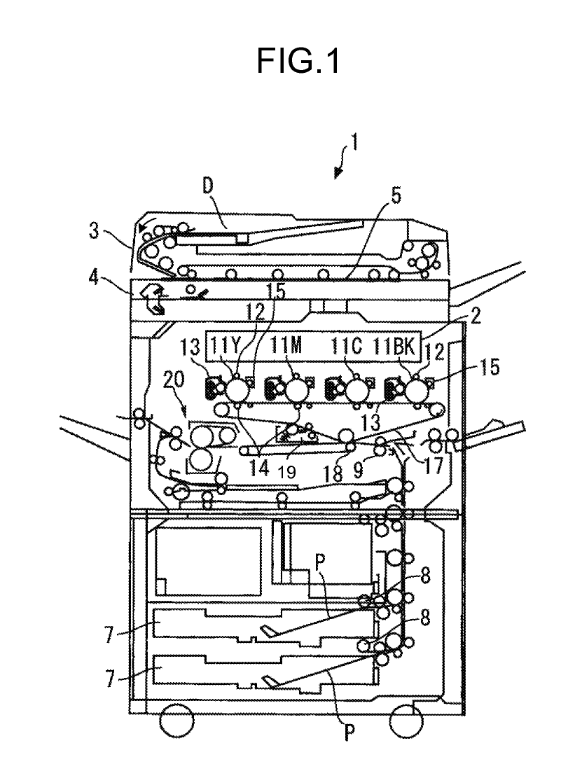

First, in FIG. 1, the entire configuration and the entire operation of an image forming apparatus will be described.

In FIG. 1, an apparatus main body 1 of a tandem type color copying machine which serves as an image forming apparatus is illustrated, wherein reference numeral 2 denotes a writing unit which emits a laser beam based on input image information, numeral 3 denotes a document conveying unit which conveys a document D to a document reading unit 4, 4 denotes a document reading unit which reads the image information of the document D, 7 denotes a paper feeding unit which accommodates a recording medium P such as transfer paper, 9 denotes a registration roller which adjusts the conveying timing of the recording medium P. Further, reference numerals 11Y, 11M, 11C, 11BK denote Photosensitive drums which serve as image carriers for forming respective colors of (yellow, magenta, cyan, and black) toner images thereon, numeral 12 denotes a charging unit which charges the surfaces of the respective photosensitive drums 11Y, 11M, 11C, and 11BK, 13 denotes a developing unit which develops the electrostatic latent images formed on the respective photosensitive drums 11Y, 11M, 11C, and 11BK, 14 denotes a transfer bias roller (a primary transfer bias roller) which transfers the toner images formed on the respective photosensitive drums 11Y, 11M, 11C, and 11BK onto the recording medium P in a state where the toner images are superimposed to each other, 15 denotes a process cartridge, and 15a denotes a cleaning unit which collects non-transferred toner on each of the respective photosensitive drums 11Y, 11M, 11C, and 11BK.

Further, reference numeral 17 denotes an intermediate transfer belt to which plural colors of toner images are transferred so that the toner images are superimposed to each other, 18 denotes a secondary transfer bias roller which transfers the color toner image on the intermediate transfer belt 17 onto the recording medium P, 19 denotes an intermediate transfer belt cleaning unit which cleans the intermediate transfer belt 17, and 20 denotes a fixing device which fixes an unfixed image on the recording medium P.

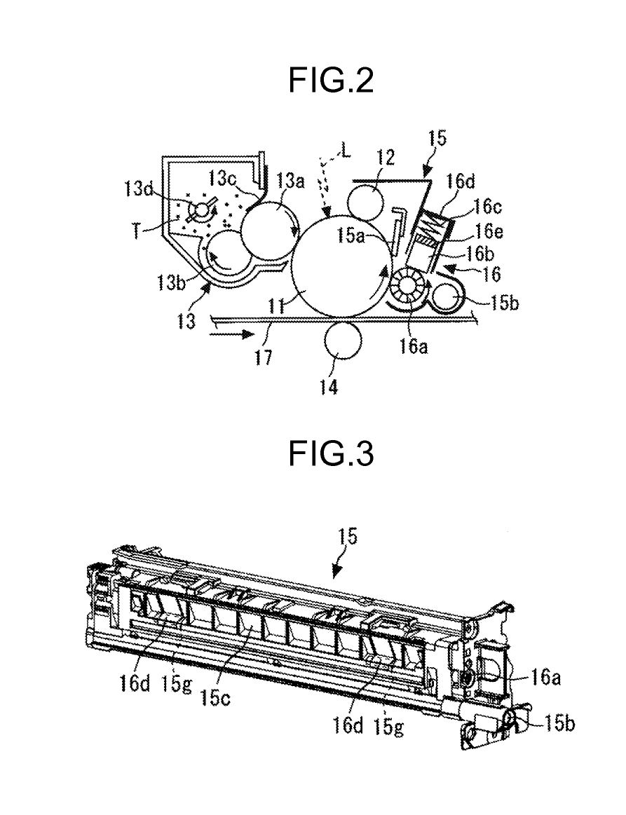

Hereinafter, the general color image forming operation in the image forming apparatus will be described. Furthermore, the image forming process which is performed on the photosensitive drums 11Y, 11M, 11C, and 11BK may be also described by referring to FIG. 2.

First, the document D is conveyed from a platen by a carriage roller of the document conveying unit 3 in the direction depicted by the arrow in the drawing, and is placed on an exposure glass 5 of the document reading unit 4. Then, the image information of the document D which is placed on the exposure glass 5 is optically read in the document reading unit 4.

Specifically, the document reading unit 4 scans the image of the document D on the exposure glass 5 while the image is irradiated by a beam which is emitted from an illuminating lamp. Then, the beam reflected by the document D forms an image on a color sensor through a mirror group and a lens. The color image information of the document D is read for each color separated beam of RGB (red, green, and blue) in the color sensor, and is converted into an electrical image signal. Furthermore, a data processing section performs processes such as a color converting process, a color correcting process, and a spatial frequency correcting process based on the color separation image signals of RGB, and obtains color image information of yellow, magenta, cyan, and black.

Then, the image information items of the respective colors, yellow, magenta, cyan, and black are transmitted to the writing unit 2. Then, laser beams L based on the image information items of the respective colors (see FIG. 2) are respectively irradiated from the writing unit 2 onto the corresponding photosensitive drums 11Y, 11M, 11C, and 11BK.

On the other hand, the four photosensitive drums 11Y, 11M, 11C, and 11BK respectively rotate in the counter-clockwise direction of FIG. 1. Then, first, the surfaces of the photosensitive drums 11Y, 11M, 11C, and 11BK are evenly charged at the portions where the surfaces face the charging units 12 (which is a charging process). In this way, charging potentials are formed on the photosensitive drums 11Y, 11M, 11C, and 11BK. Subsequently, the surfaces of the charged photosensitive drums 11Y, 11M, 11C, and 11BK respectively reach the laser beam irradiating positions.

In the writing unit 2, the laser beams, which correspond to the image signals generated from four light sources, are emitted so as to correspond to the respective colors. The respective laser beams pass through optical paths which are different for the respective color elements of yellow, magenta, cyan, and black (which is an exposure process).

The laser beam which corresponds to the yellow element is irradiated to the surface of the first photosensitive drum 11Y from the left side of the drawing paper. At this time, the laser beam of the yellow element scans the photosensitive drum 11Y in the rotating shaft direction (the main-scanning direction) by a polygon mirror which rotates at a high speed. In this way, the electrostatic latent image which corresponds to the yellow element is formed on the photosensitive drum 11Y which is charged by the charging unit 12.

In the same way, the laser beam which corresponds to the magenta element is irradiated to the surface of the second photosensitive drum 11M from the left side of the drawing paper, so that the electrostatic latent image which corresponds to the magenta element is formed on the surface thereof. The laser beam of the cyan element is irradiated to the surface of the third photosensitive drum 11C from the left side of the drawing paper, so that the electrostatic latent image of the cyan element is formed on the surface thereof. The laser beam of the black element is irradiated to the surface of the fourth photosensitive drum 11BK from the left side of the drawing paper, so that the electrostatic latent image of the black element is formed on the surface thereof.

Subsequently, each of the surfaces of the photosensitive drums 11Y, 11M, 11C, and 11BK having the electrostatic latent images of the respective colors formed thereon reaches a position where the surface faces the developing unit 13. Then, toners of respective colors are supplied from the respective developing units 13 onto the photosensitive drums 11Y, 11M, 11C, and 11BK, so that the latent images formed on the photosensitive drums 11Y, 11M, 11C, and 11BK are developed (which is a developing process).

Subsequently, each of the surfaces of the photosensitive drums 11Y, 11M, 11C, and 11BK subjected to the developing process reaches a position where the surface faces the intermediate transfer belt 17. Here, the transfer bias roller 14 is installed at each facing position so as to come into contact with the inner peripheral surface of the intermediate transfer belt 17. Then, the toner images of the respective colors which are formed on the photosensitive drums 11Y, 11M, 11C, and 11BK are sequentially transferred onto the intermediate transfer belt 17 at the positions of the transfer bias rollers 14 so that the toner images are superimposed to each other (which is a primary transfer process).

Then, each of the surfaces of the photosensitive drums 11Y, 11M, 11C, and 11BK subjected to the primary transfer process reaches a position where the surface faces a cleaning blade 15a (a cleaning unit). Then, each cleaning blade 15a collects the non-transferred toner which remains on each of the photosensitive drums 11Y, 11M, 11C, and 11BK (which is a cleaning process).

Subsequently, the surfaces of the photosensitive drums 11Y, 11M, 11C, and 11BK pass through a neutralization unit (not illustrated), whereby a series of image forming processes in the photosensitive drums 11Y, 11M, 11C, and 11BK is completed.

On the other hand, the intermediate transfer belt 17 that has the toners of the respective colors transferred from the surfaces of the photosensitive drums 11Y, 11M, 11C, and 11BK so as to be superimposed to each other (to be carried thereon) travels in the clockwise direction in the drawing, so that the intermediate transfer belt reaches a position where it faces the secondary transfer bias roller 18. Then, the color toner image which is carried on the intermediate transfer belt 17 is transferred onto the recording medium P at the position where the intermediate transfer belt faces the secondary transfer bias roller 18 (which is a secondary transfer process).

Subsequently, the surface of the intermediate transfer belt 17 reaches the position of the intermediate transfer belt cleaning unit 19. Then, the non-transferred toner which is attached onto the intermediate transfer belt 17 is collected in the intermediate transfer belt cleaning unit 19, whereby a series of transfer processes in the intermediate transfer belt 17 is completed.

Here, the recording medium P which is conveyed to a gap (which is a secondary transfer nip) between the intermediate transfer belt 17 and the secondary transfer bias roller 18 is conveyed from the paper feeding unit 7 through the registration roller 9 and the like.

Specifically, the recording medium P which is fed by a paper feeding roller 8 from the paper feeding unit 7 accommodating the recording medium P passes through the feed guide, and is guided to the registration roller 9. The recording medium P which reaches the registration roller 9 is conveyed toward the secondary transfer nip at an appropriate timing.

Then, the recording medium P onto which the full color image is transferred is guided by the conveying belt toward the fixing device 20. In the fixing device 20, the color image is fixed onto the recording medium P in the nip between the fixing belt and the pressing roller.

Then, the recording medium P subjected to the fixing process is discharged to the outside of the apparatus main body 1 by a discharging roller as an output image, whereby a series of image forming processes is completed.

Next, referring to FIG. 2, the image forming unit of the image forming apparatus will be described in detail.

As illustrated in FIG. 2, the image forming unit includes: a photosensitive drum 11 which serves as an image carrier; the charging unit 12 (a roller charging device) which charges the photosensitive drum 11; the developing unit 13 (a developing unit) which develops an electrostatic latent image formed on the photosensitive drum 11; the cleaning blade 15a (a cleaning unit) which collects the non-transferred toner on the photosensitive drum 11; a lubricant supplying device 16 (the lubricant supplying unit) which supplies a lubricant onto the photosensitive drum 11; and the like.

Then, in the embodiment, the photosensitive drum 11, the charging unit 12, the cleaning blade 15a (the cleaning unit), and the lubricant supplying device 16 which constitute the image forming unit are integrated as a process cartridge 15, and are configured to be removable from the apparatus main body 1 in the form of the process cartridge 15. Further, the developing unit 13 is configured as a unit which is separated from the process cartridge 15 and is removable from the apparatus main body 1.

Furthermore, since the image forming units (or the process cartridges) of the respective colors have substantially the same structure, the image forming units or the process cartridges are illustrated without the reference signs of alphabets (Y, C, M, and BK) in FIGS. 2 to 10.

Here, the photosensitive drum 11 which serves as an image carrier is a negatively charged organic photosensitive drum, and is obtained by forming a photosensitive layer or the like on a drum-like conductive supporting member.

Although not illustrated in the drawings, the photosensitive drum 11 is obtained by sequentially stacking an under coating layer serving as an insulating layer, a charge generating layer and a charge transporting layer serving as photosensitive layers, and a protecting layer (a surface layer) on a conductive support member serving as a base layer.

As the conductive support member (the base layer) of the photosensitive drum 11, a conductive material which has a volume resistance of 10¹⁰ Ωcm or less may be used.

The charging unit 12 (the roller charging device) is a roller member which is obtained by coating an elastic layer having an intermediate resistance on an outer periphery of a conductive core, and is disposed so as to come into contact with the photosensitive drum 11 at the downstream of the rotation direction of the photosensitive drum 11 with respect to the lubricant supplying device 16. Furthermore, the charging unit 12 (the roller charging device) may be disposed so as to face the photosensitive drum 11 without coming into contact therewith.

Then, a predetermined voltage is applied from a power supply (not illustrated) to the charging unit 12, so that the charging unit evenly charges the surface of the photosensitive drum 11 which is disposed to face the charging unit.

The developing unit 13 is disposed so that a developing roller 13a comes into contact with the photosensitive drum 11, and a developing field (a developing nip portion) is formed between the both members. A toner T (one-component developer) is accommodated inside the developing unit 13. Then, the developing unit 13 develops the electrostatic latent image which is formed on the photosensitive drum 11 (the toner image is developed).

Specifically, referring to FIG. 2, the developing unit 13 of the embodiment is an one-component developing type developing unit, and includes the developing roller 13a (the developer carrier), a supplying roller 13b, a doctor blade 13c serving as a thinning member, an agitating member 13d, and the like.

The developing unit 13 with this configuration is operated as below.

First, a part of the toner which is supplied and accommodated inside the developing unit 13 is carried in the supplying roller 13b. The toner which is carried in the supplying roller 13b undergoes triboelectric charging at the contact portion against the developing roller 13a, and moves onto the developing roller 13a so as to be carried thereon. Subsequently, the toner which is carried on the developing roller 13a is thinned and equalized at the position of the doctor blade 13c, and reaches the contact position (the developing field) against the photosensitive drum 11. Then, at this position, the toner is absorbed to the latent image which is formed on the photosensitive drum 11 by the electric field (developing electric field) formed in the developing field.

Furthermore, in the embodiment, in order to improve the image quality, a spherical toner which has a circularity degree of 0.98 or more is used as the toner T. The ‘circularity degree’ is an average circularity degree which is measured by a flow particle image analyzer (trade name: FPIA-2000, manufactured by Sysmex Corporation). Specifically, 0.1 to 0.5 mL of a surface acting agent (desirably, alkyl benzene sulfonate) as a dispersing agent is added into 100 to 150 mL of water obtained by removing impure solid materials in a container in advance. Further, 0.1 to 0.5 g of measurement sample (toner) is added. Subsequently, a suspending solution in which the toner is dispersed undergoes dispersion treatment for about 1 to 3 minutes using an ultrasonic dispersing unit so that the concentration of the dispersed solution becomes 3000 to 10000/μL, and the dispersed solution is set in the above-described analyzer. In this state, the shape and the distribution of the toner are measured.

As the spherical toner, a toner which is formed in a spherical shape by performing heat treatment or the like on distorted toners (crushed toner) having different shapes according to a crushing method that has been widely used from the past, a toner which is produced by a polymerization method, and the like may be used.

In the case where this spherical toner is used, in the related art, the toner goes through a small gap formed between the cleaning blade 15a and the photosensitive drum 11 and comes out therefrom, which results in a cleaning defect. However, in this embodiment, a lubricant is coated on the surface of the photosensitive drum 11 by the lubricant supplying device 16, so that toner detachability (removable property) on the photosensitive drum 11 is improved. As a result, the occurrence of the cleaning defect is suppressed.

The cleaning blade 15a is disposed at the downstream side of the rotation direction of the photosensitive drum 11 with respect to the lubricant supplying device 16. The cleaning blade 15a is formed of a rubber material such as urethane rubber, and comes into contact with the surface of the photosensitive drum 11 at a predetermined angle or a predetermined pressure. Accordingly, attachment such as non-transferred toner attached onto the photosensitive drum 11 is mechanically scraped, so that the attachments are collected into the process cartridge 15. Then, the toner which is collected into the process cartridge 15 is conveyed as waste toner by a conveying coil 15b toward a waste toner collecting container (not illustrated). Here, as the attachment which is attached onto the photosensitive drum 11, there are paper powders which are produced from the recording medium P (paper), discharge products which are produced on the photosensitive drum 11 at the time of discharging using the roller charging device 12a, additives which are added to the toner, and the like, in addition to the non-transferred toner.

Further, the cleaning blade 15a of the embodiment also serves as a thinning blade which thins the lubricant which is supplied onto the photosensitive drum 11 by a lubricant supplying roller 16a.

The lubricant supplying device 16 includes: a solid lubricant 16b; a lubricant supplying roller 16a (a brush-like roller) which slides on the photosensitive drum 11 and the solid lubricant 16b; a holding member 16e which holds the solid lubricant 16b; a compressing spring 16c (a biasing member) which biases the solid lubricant 16b toward the lubricant supplying roller 16a together with the holding member 16e; and the like.

A lubricant is supplied onto the photosensitive drum 11 by the lubricant supplying device 16 with this configuration. Then, the lubricant which is supplied onto the photosensitive drum 11 is thinned by the cleaning blade 15a disposed at the downstream of the lubricant supplying device 16.

Hereinafter, the configuration and the operation of the lubricant supplying device 16 (the lubricant supplying unit) of the embodiment will be described in detail.

As illustrated in FIG. 2, the lubricant supplying device 16 includes: the solid lubricant 16b; the lubricant supplying roller 16a (the brush-like roller) which slides on the photosensitive drum 11 and the solid lubricant 16b and has a brush bristle circumferentially provided thereon; the holding member 16e (the holding plate) which holds the solid lubricant 16b; the compressing spring 16c which biases the solid lubricant 16b toward the lubricant supplying roller 16a through the holding member 16e; and the like.

The lubricant supplying roller 16a (the brush-like roller) is obtained in such a manner that brush bristles having a length (a shag) in the range of 0.2 to 20 mm (desirably, 0.5 to 10 mm) and implanted on a ground fabric are wound on a core metal in a spiral shape.

When the length of each of the brush bristles becomes longer than 20 mm, the brush bristles are fallen and tilted in a predetermined direction due to the repeated contact-sliding action thereof against the photosensitive drum 11 with the elapse of time, which results in a problem in which the performance of scraping the solid lubricant 16b or the performance of removing the toner from the photosensitive drum 11 is degraded. On the contrary, when the length of each of the brush bristles is less than 0.2 mm, the physical contact force against the solid lubricant 16b or the photosensitive drum 11 becomes insufficient. Thus, it is desirable that the length of each of the brush bristles be in the above-described range.

The lubricant supplying roller 16a rotates in the counter direction (the counter-clockwise direction of FIG. 2) so as to come into contact with the photosensitive drum 11 which rotates in the counter-clockwise direction of FIG. 2. Further, the lubricant supplying roller 16a (the brush bristle) is disposed so as to slide on the solid lubricant 16b and the photosensitive drum 11. Accordingly, when the lubricant supplying roller 16a rotates, the lubricant supplying roller scrapes the lubricant from the solid lubricant 16b, the scraped lubricant is conveyed to a contact position against the photosensitive drum 11, and then the lubricant is coated on the photosensitive drum 11.

The compressing spring 16c is disposed in rear of the solid lubricant 16b so as to eliminate an uneven contact state between the lubricant supplying roller 16a and the solid lubricant 16b, and is configured to bias the solid lubricant 16b which is held (attached) to the holding member 16e toward the lubricant supplying roller 16a. Here, one end of the compressing spring 16c comes into contact with the holding member 16e, and the other end thereof comes into contact with a cover member 16d which is installed in a casing 15c so as to be attachable thereto and detachable therefrom. However, this will be described in detail later.

In this embodiment, the solid lubricant 16b is mainly formed of zinc stearate. Specifically, the solid lubricant 16b is obtained by dissolving lubricant additive mainly including zinc stearate, and it is desirable that the solid lubricants have no adverse effect due to over-coating and have a sufficient lubricating property.

The zinc stearate is a typical lamella crystalline powder. The lamella crystalline has a laminated shape in which amphipathic molecules are self-organized, and the crystalline may be easily separated and slid according to the separate layers when a shearing force is applied thereto. Thus, the surface of the photosensitive drum 11 may be made to have low friction. That is, the surface of the photosensitive drum 11 may be effectively covered by a small amount of lubricant due to the lamella crystalline which evenly covers the surface of the photosensitive drum 11 due to the shearing force applied thereto.

Furthermore, as the solid lubricant 16b, a lubricant which has a stearate group such as barium stearate, ferric stearate, nickel stearate, cobalt stearate, copper stearate, strontium stearate, and calcium stearate may be used in addition to the zinc stearate. Further, zinc oleate, barium oleate, and lead oleate as the same fatty acid group, a compound similar to stearate hereinafter, zinc palmitic acid, barium palmitic acid, lead palmitic acid, and a compound similar to stearate hereinafter may be used. In addition, as a fatty acid group, caprylic acid, lionlenic acid, corynoline acid, and the like may be used. Furthermore, wax such as candelilla wax, carnauba wax, rice wax, vegetable wax, oba oil, beeswax, or lanolin may be used. These examples may easily become an organic solid lubricant, and has good compatibility with the toner.

When the solid lubricant 16b is coated on the surface of the photosensitive drum 11 through the lubricant supplying roller 16a, a powder-like lubricant is coated on the surface of the photosensitive drum 11. However, in this state, the lubricating performance is not sufficiently exhibited. For this reason, the cleaning blade 15a serves as a thinning blade which equalizes the lubricant. The lubricant is coated on the photosensitive drum 11 by the cleaning blade 15a, so that the lubricant may sufficiently exhibit the lubricating performance thereof.

At this time, the powder-like lubricant to be coated by the lubricant supplying roller 16a is thinned into the level of a molecule film on the photosensitive drum 11 by the cleaning blade 15a as the powder of the lubricant becomes minute.

Hereinafter, referring to FIGS. 3 to 10, the characteristic configuration and the characteristic operation of the lubricant supplying device 16 (the process cartridge 15) of the embodiment will be described.

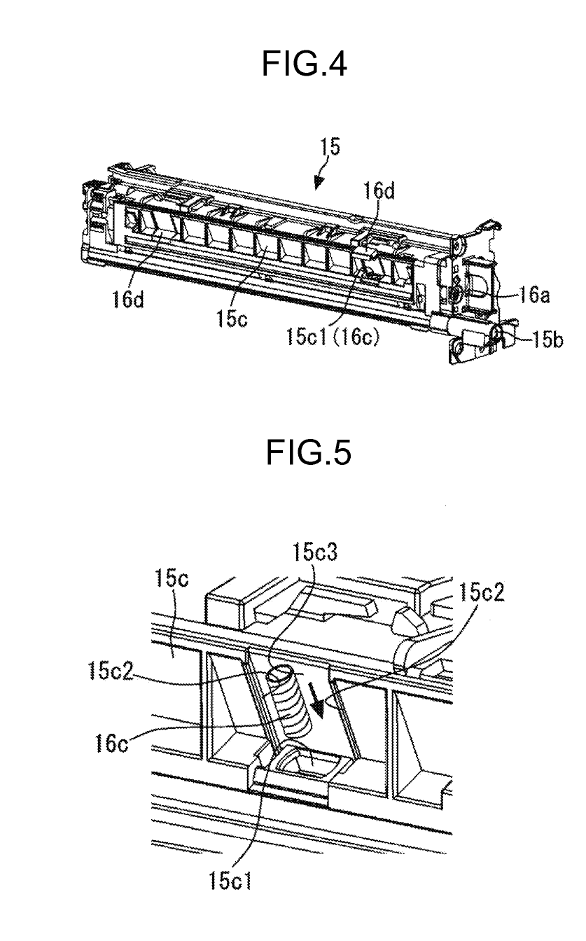

FIG. 3 is a perspective view illustrating the process cartridge 15 in which the lubricant supplying device 16 is installed. Further, FIG. 4 is a perspective view illustrating a state where one of two cover members 16d is attached to and detached from the process cartridge 15 of FIG. 3.

Referring to FIGS. 3 and 4, in the casing 15c (the exterior cover) configured to cover the outside of the process cartridge 15 (the lubricant supplying device 16), an opening portion 15c1 is formed at each of both end portions of the casing 15c in the width direction (which is a direction corresponding to the direction perpendicular to the drawing paper of FIG. 2), and the cover member 16d is configured to be attached to and detached from the opening portion 15c1 by patch-fastening.

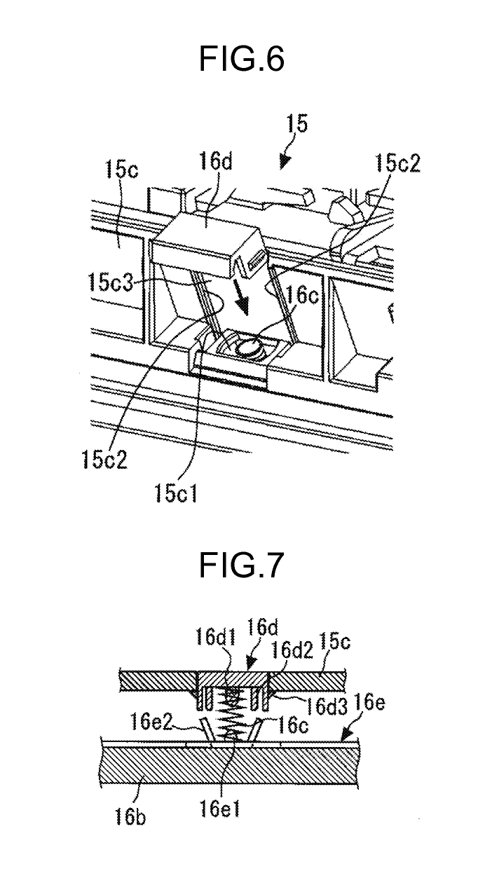

Here, referring to FIGS. 4 and 6, the opening portion 15c1 of the casing 15c allows the other end of the compressing spring 16c having one end being in contact with the holding member 16e for holding the solid lubricant 16b to be exposed therethrough. Then, the cover member 16d is attached to the opening portion 15c1 so as to come into contact with the other end of the compressing spring 16c exposed from the opening portion 15c1, and determines the biasing force of the compressing spring. That is, referring to FIG. 7 and the like, when the cover member 16d is attached to the casing 15c so as to be fitted to the opening portion 15c1, the compressing spring 16c is set between the cover member 16d and the holding member 16e, the use length of the compressing spring 16c is determined, and the solid lubricant 16b is biased toward the lubricant supplying roller 16a at a predetermined pressing force together with the holding member 16e.

With such a configuration, since the compressing spring 16c may be set in a pressurized state while the other end (which is a portion serving as a pressing position) of the compressing spring 16c is seen, a problem can be suppressed, in which the compressing spring 16c is attached in a buckled state or the compressing spring 16c slips off during the assembly process. That is, the assembly workability and the maintenance workability of the compressing spring 16c of the process cartridge 15 (the lubricant supplying device 16) may be remarkably improved.

The operation in which the compressing spring 16c and the cover member 16d are assembled to the process cartridge 15 (the lubricant supplying device 16) may be performed after the other members are completely assembled. That is, in the order illustrated in FIGS. 5 and 6, the compressing spring 16c and the cover member 16d are sequentially set in the process cartridge 15. Thus, even in the case where the press-contact force of the solid lubricant 16b against the lubricant supplying roller 16a needs to be changed, the cover member 16d may be easily attached and detached and the compressing spring 16c having a different spring constant may be simply replaced.

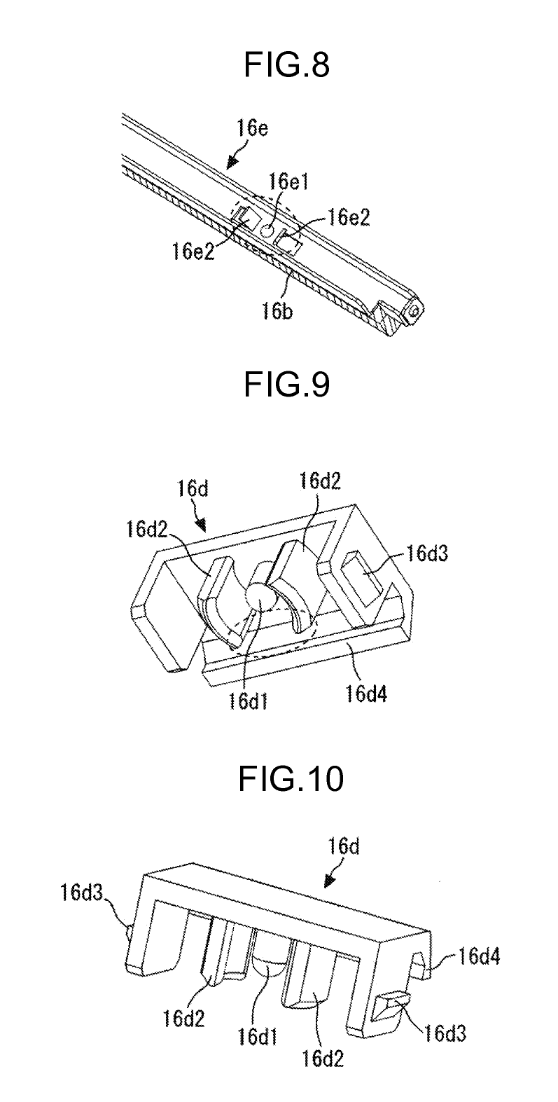

Specifically, as illustrated in FIG. 5, in the process cartridge 15 (the lubricant supplying device 16) in which the members other than the compressing spring 16c and the cover member 16d are completely assembled, the compressing spring 16c is set inward from the opening portion 15c1 of the casing 15c (which is the movement in the direction depicted by the arrow of FIG. 5). At this time, referring to FIGS. 7 and 8 and the like, the compressing spring 16c is set so that the inner peripheral portion of one end (which is the downside of FIG. 5) of the compressing spring is inserted into a protrusion portion 16e1 of the holding member 16e and a part of the outer peripheral portion of the one end is covered by an upright portion 16e2 of the holding member 16e. Furthermore, referring to FIG. 6, in the compressing spring 16c of which one end comes into contact with the holding member 16e, the outer peripheral portion of the other end (which is the exposure side from the opening portion 15c1 in FIG. 6) is covered by the opening portion 15c1. The other end of the compressing spring 16c in such a state is not fixed and held, but the posture thereof is maintained to a certain extent by the protrusion portion 16e1, the upright portion 16e2, and the opening portion 15c1. For this reason, later, when the cover member 16d is set from the upside so as to be fitted to the opening portion 15c1 as illustrated in FIG. 6, a positional deviation of the compressing spring 16c with respect to the cover member 16d scarcely occurs.

Furthermore, as illustrated in FIG. 8, the holding member 16e is formed in a substantially box shape by bending sheet metal, and the protrusion portion 16e1 and the upright portion 16e2 are respectively formed at both end portions of the holding member in the width direction.

The protrusion portion 16e1 of the holding member 16e is formed so as to protrude in a semi-spherical shape, and is inserted into the inner peripheral portion of the compressing spring 16c as described above. The protrusion portion 16e1 is configured to slightly come into contact with (or not to come into contact with) the inner peripheral portion of the compressing spring 16c so as not to affect the spring force of the compressing spring 16c. Since the protrusion portion 16e1 is provided, as illustrated in FIG. 6, the posture of the compressing spring 16c which is set from the opening portion 15c1 may be stabilized.

Further, the upright portions 16e2 of the holding member 16e are formed by bending so that the bending angle becomes smaller than 90° at a position where the protrusion portion 16e1 is interposed therebetween in the width direction, and are uprightly formed so as to cover the outer peripheral portion of the compressing spring 16c in a non-contact state as described above. Since the upright portion 16e2 is provided, as illustrated in FIG. 6, the compressing spring 16c which is set from the opening portion 15c1 may be prevented from being fallen down.

Furthermore, in the embodiment, the bent portion of the holding member 16e encircled by the dashed line of FIG. 8 is also a second upright portion which has a function of preventing the compressing spring 16c from being fallen down. Further, in the embodiment, a part of the outer peripheral portion of the compressing spring 16c is covered in the upright portion 16e2 and the second upright portion. However, the entirety (the entire circumference) of the outer peripheral portion of the compressing spring 16c may be covered by the upright portion.

Here, in the embodiment, referring to FIGS. 5 and 6, the casing 15c1 is provided with an inclined wall surface 15c3 (the wall surface) and a guide portion 15c2 which are used to guide the cover member 16d to be attached to the opening portion 15c1. In other words, a groove portion which guides the cover member 16d is formed by the inclined wall surface 15c3 and the guide portion 15c2.

Specifically, the inclined wall surface 15c3 which serves as a wall surface is inclined along the biasing direction of the compressing spring 16c. Then, as illustrated in FIG. 6, the cover member 16d is smoothly attached to a position where it blocks the opening portion 15c1 in such a manner that the cover member 16d is slid in the direction depicted by the arrow along the inclined surface 15c3 while the end surface of the cover member 16d comes into contact with the inclined surface 15c3. Furthermore, since the inclined wall surface 15c3 is inclined in parallel to the biasing direction of the compressing spring 16c, the cover member 16d which is attached along the inclined wall surface 15c3 comes into contact with the tensile spring 16c in the direction parallel to the biasing direction, so that the tensile spring 16c scarcely falls down due to the attachment of the cover member 16d.

Further, the guide portions 15c2 are uprightly formed at both end portions of the inclined wall surface 15c3 in the width direction, and are used to guide both end portions of the cover member 16d in the width direction. Then, as illustrated in FIG. 6, the cover member 16d is smoothly attached to a position where it blocks the opening portion 15c1 in such a manner that the cover member 16d is slid in the direction depicted by the arrow while the cover member 16d is gripped so as to be interposed between the guide portions 15c2.

Then, referring to FIG. 7, in the cover member 16d, claw portions 16d3 and an eave portion 16d4 are respectively locked (patch-fastened) to the casing 15c through the engagement with the engagement portion of the casing 15c in the state where a boss portion 16d1 is loosely inserted into the inner peripheral portion of the other end of the compressing spring 16c and wall portions 16d2 cover the outer peripheral portion of the other end of the compressing spring 16c.

Specifically, referring to FIGS. 9 and 10, the cover member 16d is provided with the boss portion 16d1, the wall portions 16d2, the claw portions 16d3, the eave portion 16d4, and the like.

The boss portion 16d1 of the cover member 16d is a substantially columnar member of which the front end is formed in a semi-spherical shape, and is inserted in the compressing spring 16c having a gap from the inner peripheral portion of the compressing spring. Since the boss portion 16d1 is provided, as illustrated in FIG. 7, the posture of the compressing spring 16c which is set between the cover member 16d and the holding member 15e may be stabilized.

Further, the wall portions 16d2 of the cover member 16d are respectively formed at the position where the boss portion 16d1 is interposed therebetween in the width direction so as to have a circular-arc shape, and are uprightly formed so as to cover a part of the outer peripheral portion of the compressing spring 16c in a non-contact state. Since the wall portions 16d2 are provided, as illustrated in FIG. 7, the compressing spring 16c which is set between the cover member 16d and the holding member 15e may be prevented from being fallen down.

Furthermore, in the embodiment, a part of the outer peripheral portion of the compressing spring 16c is covered by the wall portions 16d2, but the wall portions 16d2 may be formed so as to cover the entirety (the entire circumference) of the outer peripheral portion of the compressing spring 16c.

Furthermore, the claw portions 16d3 of the cover member 16d are formed so as to protrude from the arm portions of both end portions of the cover member 16d in the width direction as illustrated in FIGS. 9 and 10. Then, at the time when the cover member 16d is attached to the opening portion 15c1, the arm portions are elastically deformed due to the external force applied thereto so as to avoid the interference with the edge portion of the opening portion 15c1. Then, when the external force is eliminated later, the elastically deformed arm portion is restored, so that the claw portions 16d3 engage with the engagement portions of the opening portion 15c1 (which is the state of FIG. 7). Accordingly, the cover member 16d engages with the casing 15c (the opening portion 15c1), so that the cover member 16d does not easily slip off the casing 15c.

Further, the eave portion 16d4 of the cover member 16d is formed at a position where it does not face the inclined wall surface 15c3 in the cover member 16d as illustrated in FIGS. 9 and 10, and the front end is provided with a claw-like subject engagement portion. Then, at the time when the cover member 16d is attached to the opening portion 15c1, the eave portions 16d4 are elastically deformed due to the external force applied thereto so as to avoid the interference with the edge portion of the opening portion 15c1. Then, when the external force is eliminated, the elastically deformed eave portion 16d4 is restored, so that the subject engagement portion engages with the engagement portion of the opening portion 15c1 (which is the state of FIG. 3). Accordingly, the cover member 16d engages with the casing 15c (the opening portion 15c1), so that the cover member 16d does not easily slip off the casing 15c.

Here, in the embodiment, the wall portion 16d2 of the cover member 16d is provided with a notch portion (which is a portion encircled by the dashed line of FIG. 9) which is formed so as not to face the inclined wall surface 15c3 of the casing 15c when the cover member is attached to the opening portion 15c1 of the casing 15c. That is, the wall portion 16d2 is not formed in a columnar shape, but a notch portion is formed therein so as to face a worker who attaches the cover member 16d to the opening portion 15c1.

With such a configuration, the worker who attaches the cover member 16d to the opening portion 15c1 may completely set the cover member 16d while observing the compressing spring 16c exposed from the opening portion 15c1 through the notch portion. For this reason, the assembly defect of the compressing spring 16c may be more reliably suppressed.

Here, in the embodiment, referring to FIG. 3, the cover member 16d which is installed in the opening portion 15c1 and a seal material 15g which covers the periphery thereof from outside are attached to the casing 15c. That is, first, as described above by referring to FIGS. 5 and 6 and the like, when the compressing spring 16c and the cover member 16d are completely set in the opening portion 15c1, the seal material 15g is attached onto the casing 15c so as to cover the cover member 16d and the periphery thereof from outside.

The seal material 15g is formed of a flexible material such as Mylar having a thickness of 0.1 mm or less, and the attachment surface against the casing 15c is provided with a double-faced tape. Then, the seal material adheres to the casing 15c and the cover member 16d so as to seal the gap (the boundary) between the cover member 16d and the casing 15c (the opening portion 15c1).

With such a configuration, a problem may be suppressed in which the toner inside the process cartridge 15 leaks to the outside from the gap between the cover member 16d and the casing 15c (the opening portion 15c1). Furthermore, the cover member 16d is more strongly fixed to the casing 15c.

As described above, according to the embodiment, the casing 15c is provided with the opening portion 15c1 which allows the other end of the compressing spring 16c having one end being in contact with the holding member 16e to be exposed therethrough, and the cover member 16d is provided which is installed in the opening portion 15c1 so as to be attachable thereto and detachable therefrom so that the cover member comes into contact with the other end of the compressing spring 16c. Accordingly, the assembly defect of the compressing spring 16c may be prevented which is used to bias the solid lubricant 16b in the press-contact direction.

Furthermore, in the embodiment, the photosensitive drum 11, the charging unit 12, the cleaning blade 15a (the cleaning unit), and the lubricant supplying device 16 of the image forming unit are integrated with each other so as to configure the process cartridge 15, so that the image forming unit may be decreased in size and the maintenance workability thereof is improved.

On the contrary, the developing unit 13 may also constitute the process cartridge 15. Furthermore, the respective members 11, 12, 13, 15a, and 16 of the image forming unit may not be provided as members constituting the process cartridge, and may be installed in the apparatus main body 1 so as to be separately replaceable. Even in this case, the same effect as that of the embodiment may be obtained.

Further, in the embodiment, the invention is applied to the image forming apparatus on which the one-component developing type developing unit 13 using one-component developer is mounted. However, the invention may be, of course, applied to an image forming apparatus on which a two-component developing type developing unit 13 using two-component developer is mounted.

Further, in the embodiment, the invention is applied to the tandem type color image forming apparatus which uses the intermediate transfer belt 17. On the contrary, the invention may be applied to other image forming apparatuses such as a tandem type color image forming apparatus using a transfer conveying belt (which is an apparatus in which toner images on plural photosensitive drums arranged to face a transfer conveying belt are transferred onto a recording medium conveyed by a transfer conveying belt so that the toner images are superimposed to each other) or a monochrome image forming apparatus. Then, even in this case, the same effect as that of the embodiment may be obtained.

Further, in the embodiment, the invention is applied to the lubricant supplying device 16 which supplies the lubricant onto the photosensitive drum 11 serving as the image carrier. However, the invention may be, of course, applied to a lubricant supplying device which supplies a lubricant to an image carrier other than the photosensitive drum 11 (for example, a lubricant supplying device which supplies a lubricant onto the intermediate transfer belt 17). Then, even in this case, since the cover member 16d is provided which is installed in the opening portion 15c1 so as to be attachable thereto and detachable therefrom so that the cover member comes into contact with the other end of the compressing spring 16c as in the embodiment, the same effect as that of the embodiment may be obtained.

Further, in the embodiment, the brush-like roller having brush bristles circumferentially provided thereon is used as the lubricant supplying roller 16a. However, a sponge-like roller having a sponge-like member (an elastic material) circumferentially provided thereon may be used as the lubricant supplying roller 16a. Then, even in this case, since the cover member 16d is provided which is installed in the opening portion 15c1 so as to be attachable thereto and detachable therefrom so that the cover member comes into contact with the other end of the compressing spring 16c as in the embodiment, the same effect as that of the embodiment may be obtained.

In the invention, the casing is provided with the opening portion which allows the other end of the compressing spring, having one end being in contact with the holding member, to be exposed therethrough, and the casing is further provided with the cover member which is installed in the opening portion in a manner of being removable from the opening portion so that the cover member comes into contact with the other end of the compressing spring. Accordingly, the invention provides the lubricant supplying device, the process cartridge, and the image forming apparatus in which the assembly defect of the compressing spring used to bias the solid lubricant in the press-contact direction scarcely occurs.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A lubricant supplying device that supplies a lubricant to an image carrier that carries a toner image, the lubricant supplying device comprising:
a lubricant supplying roller that rotates in a predetermined direction and slides on the image carrier;
a solid lubricant that slides on the lubricant supplying roller;
a holding member that holds the solid lubricant;
a compressing spring with one end being brought into contact with the holding member, thereby biasing the solid lubricant toward the lubricant supplying roller; and
a casing that covers the outside of the device,
wherein the casing includes
an opening portion that allows the other end of the compressing spring, having the one end coming into contact with the holding member, to be exposed therethrough, and
a cover member that is installed in the opening portion in a removable manner so that the cover member comes into contact with the other end of the compressing spring and determines a biasing force of the compressing spring.

2. The lubricant supplying device according to claim 1,
wherein the cover member includes
a boss portion that is loosely inserted into an inner peripheral portion of the compressing spring, and
a wall portion that is uprightly formed so as to cover a part or an entirety of an outer peripheral portion of the compressing spring.

3. The lubricant supplying device according to claim 2,
wherein a notch portion is formed in the wall portion of the cover member so as not to face a wall surface of the casing when the cover member is attached to the opening portion of the casing.

4. The lubricant supplying device according to claim 1,
wherein the holding member includes
a protrusion portion that is inserted into the inner peripheral portion of the compressing spring, and
an upright portion that is uprightly formed so as to cover a part or an entirety of the outer peripheral portion of the compressing spring.

5. The lubricant supplying device according to claim 1,
wherein the casing includes
a wall surface that is inclined along a biasing direction of the compressing spring so as to guide the cover member attached to the opening portion, and
a guide portion that guides both end portions of the cover member in the width direction so as to guide the cover member attached to the opening portion.

6. The lubricant supplying device according to claim 1,
wherein the opening portion of the casing is formed so as to cover the outer peripheral portion of the compressing spring having one end coming into contact with the holding member.

7. The lubricant supplying device according to claim 1,
wherein a seal material that covers the cover member installed in the opening portion and a periphery portion of the cover member from the outside is attached to the casing.

8. A process cartridge that is installed in an image forming apparatus main body so as to be attachable thereto and detachable therefrom, the process cartridge comprising a lubricant supplying device and an image carrier; wherein the lubricant supplying device comprises:
a lubricant supplying roller that rotates in a predetermined direction and slides on the image carrier;
a solid lubricant that slides on the lubricant supplying roller;
a holding member that holds the solid lubricant;
a compressing spring with one end being brought into contact with the holding member, thereby biasing the solid lubricant toward the lubricant supplying roller; and
a casing that covers the outside of the device,
wherein the casing includes
an opening portion that allows the other end of the compressing spring, having the one end coming into contact with the holding member, to be exposed therethrough, and
a cover member that is installed in the opening portion in a removable manner so that the cover member comes into contact with the other end of the compressing spring and determines a biasing force of the compressing spring.

9. The process cartridge according to claim 8, further comprising:
a cleaning blade that is installed on the downstream side with respect to the lubricant supplying device in a rotation direction of the image carrier so as to clean a surface of the image carrier.

10. An image forming apparatus comprising:
a lubricant supplying device and an image carrier, wherein the lubricant supplying device comprises:
a lubricant supplying roller that rotates in a predetermined direction and slides on the image carrier;
a solid lubricant that slides on the lubricant supplying roller;
a holding member that holds the solid lubricant;
a compressing spring with one end being brought into contact with the holding member, thereby biasing the solid lubricant toward the lubricant supplying roller; and
a casing that covers the outside of the device,
wherein the casing includes
an opening portion that allows the other end of the compressing spring, having the one end coming into contact with the holding member, to be exposed therethrough, and
a cover member that is installed in the opening portion in a removable manner so that the cover member comes into contact with the other end of the compressing spring and determines a biasing force of the compressing spring.
